(19) United States
(12) Patent Application Publication
(10) Pub. No.: US 2022/0114562 A1
(43) Pub. Date: Apr. 14, 2022

(54) METHODS AND SYSTEMS FOR CONVERSION OF TRANSACTIONS TO CARBON UNITS

(71) Applicant: Greenlines Technology Inc., Vancouver (CA)

(72) Inventor: David OLIVER GOMILA, Vancouver (CA)

(21) Appl. No.: 17/496,383

(22) Filed: Oct. 7, 2021

Related U.S. Application Data
(60) Provisional application No. 63/089,264, filed on Oct. 8, 2020.

(51) Int. Cl. G06Q 10/00; G06Q 20/38; G06Q 20/40; G06Q 50/26

(52) U.S. Cl. CPC G06Q 10/30; G06Q 50/26; G06Q 20/401; G06Q 20/389

(57) ABSTRACT

System and methods for producing verifiable environmental attributes for a transaction on an online platform, by calculating item project emissions for a selected item and item baseline emissions for a substitute item, calculating project and baseline final delivery transport emissions to the user's specified destination, and extracting net emissions reductions based on the baseline and project emissions. The net emissions reductions are communicated to a system for aggregation with net emissions reductions from other transactions, and aggregated net emissions reductions are delivered to an independent system for validation and verification. Ownership of net emissions reductions may be assigned to the platform provider. Emissions may include GHG emissions generated during the product life cycle, including raw materials sourcing, production and manufacturing, supply-chain transport from factory to warehouse/distribution centre or retail store, warehouse and retail handling, customer delivery, product use and disposal and recycling process (end of life).

### RELATED APPLICATION

This application claims priority from U.S. Patent Application No. 63/089,264 filed on Oct. 8, 2020 entitled “METHODS AND SYSTEMS FOR CONVERSION OF CONSUMER TRANSACTIONS TO CARBON UNITS”. This application claims the benefit under 35 U.S.C. § 119 of U.S. Patent Application No. 63/089,264 filed on Oct. 8, 2020 entitled “METHODS AND SYSTEMS FOR CONVERSION OF CONSUMER TRANSACTIONS TO CARBON UNITS”, which is incorporated herein by reference in its entirety for all purposes.

### TECHNICAL FIELD

This present disclosure relates generally to technology for implementing carbon offsets, including methods and systems for the conversion of online purchases to quantifiable and verifiable emission reductions.

### BACKGROUND

The earth's so-called “greenhouse effect” describes the process by which radiatively active greenhouse gases (GHGs) in the planet's atmosphere, such as water vapor, carbon dioxide, methane, nitrous oxide and ozone, contribute to the downward radiation which warms the planet's surface. Increased GHG emissions, driven in large part by human activity, has strengthened the greenhouse effect and contributed to global climate change, threatening ecosystems, biodiversity, economies and human livelihood. Climate change poses one of the greatest risks to survival of the human species. A landmark report by the UN Intergovernmental Panel on Climate Change (IPCC) released in 2018 warned that there are only about a dozen years for global warming to be kept to a maximum of 1.5° C., beyond which even half a degree will significantly worsen the risks of drought, floods, extreme heat and poverty for hundreds of millions of people. With growing concerns about the pressing environmental problems caused by consumption of goods, reducing the adverse environmental impact of consumer products is emerging as a great challenge. To address the challenge, it is important to enable consumers to identify the environmental impact associated with their product uses and let them make informed decisions about how to make their consumption more sustainable. Some products (such as a cellular phone) have a large environmental impact during production (e.g. 80-90% of the GHG emissions is associated with production), while for others, like a fridge, the largest share of its environmental impact comes during the “use” phase due to the electricity consumed (75% of its GHG impact).

Choices across the product life cycle, including raw materials, production, supply-chain transport, warehouse & retail handling, customer delivery, use, disposal and recycling (end of life) all have an impact on the final GHG emissions associated with a consumer good, process or service. Additionally, consumers are increasingly conscious of their purchasing choices and how they affect their own personal carbon footprint. Studies have demonstrated that labelling products with their carbon impact has a direct effect on reducing overall emissions of their shopping carts (for example, see Michail Niamh, “Study confirms carbon label efficacy: ‘They had the predicted effect . . . lower-emission food choices’ Jan. 4, 2019, and Camilleri A R, Larrick R P, Hossain S and Patino-Echeverri D, 2019 Consumers underestimate the emissions associated with food but are aided by labels, Nature Climate Change 9 53-8). Online shopping, or e-commerce, whether by end consumers (individuals) or corporations (e.g. corporate accounts, etc.) is a rapidly expanding area. In 2019, retail e-commerce sales worldwide amounted to 3.53 trillion US dollars and this number is projected to surpass 6.5 trillion US dollars in 2023 (Source: Statista, Online shopping behavior in the United States—Statistics & Facts). COVID-19 has pulled forward a decade of e-commerce growth: the pandemic has drastically changed consumer purchasing behaviour and has accelerated the shift from offline retail to e-commerce. From 2009 to 2019, e-commerce penetration in the US increased steadily from 6% to 16% but surged to 27% in the two months following the start of the COVID-19 pandemic. Consumers are becoming accustomed to the ease and convenience of e-commerce. This means that a merchant's web presence is more important than ever, which has major implications on the future of commerce, including a new wave of direct to consumer brands. Mobile e-commerce is becoming increasingly dominant, with 54% of e-commerce activity projected to come from mobile devices in 2021.

In an effort to limit or reduce GHG emissions, carbon offset projects (also referred to as carbon reduction programs) have been implemented to formally recognize emission reductions in the form of carbon offsets or credits (typically called Certified Emission Reductions (CERs) or Verified Emission Reductions or Voluntary Emission Reductions (VERs), derived from project-based emissions reductions from a wide range of technologies and project types.). Each carbon offset represents a reduction in emissions of carbon dioxide or its equivalent (CO₂e), typically denominated in metric tons of CO₂e. A party which produces GHG emissions can offset its emissions by purchasing carbon offsets from another party which has achieved GHG reductions through certain activities. In certain cases, to comply with various regulatory obligations (such as cap-and-trade schemes), an entity that exceeds its GHG limits can purchase carbon offsets (i.e. a reduction in emissions of carbon dioxide or GHG) to offset its excess emissions and bring it into compliance. Even where there is no regulatory requirement, an entity can voluntarily purchase carbon offsets to offset its GHG emissions. The sale of carbon offsets is typically used to fund activities that reduce GHGs, such as renewable energy projects (e.g. wind farms, hydroelectric dams, biomass energy) and energy efficiency projects.

Criteria for evaluating the use of a carbon offset project include the concepts of “additionality” and a “baseline”. “Additionality” evaluates whether the GHG emission reductions achieved by an activity is additional to what would have happened if the activity had not been implemented because of the carbon offset project (i.e. the emission reduction activity is beyond business-as-usual and would not have occurred if the activity was not carried out through the carbon offset project). Additionality is generally determined with reference to a “baseline”, which can be described as the reference scenario that is characterized by the absence of the specific policy initiative that enabled the proposed activity in connection with the carbon offset project, holding all other factors constant. In the e-commerce sector, technical, financial and other implementation barriers have hindered the development of technologies that can be used to establish additionality for a carbon offset program for the online purchase of goods, processes or services. There is a need for solutions that incentivize more environmentally-sustainable purchasing choices and can be used as part of an overall technological framework to support projects that reduce or offset GHG emissions in activities associated with the e-commerce sector.

### SUMMARY OF THE DISCLOSURE

The present specification relates to methods and systems for the conversion of transactions to quantifiable and verifiable emission reductions. These emissions can be recognized as environmental attributes in the form of carbon offsets or credits. The transactions may include purchases by end consumers, Business to Business (B2B) transactions, Business to Consumers (B2C) transactions, Consumer to Consumer (C2C) transactions, and Business to Government (B2G) transactions. The transactions may be conducted over online commerce platforms, such as e-commerce platforms and online trading platforms, accounting systems, online payment systems, and the like.

One aspect provides a method of producing verifiable environmental attributes in connection with a transaction on a platform. The method includes: receiving from a user an input specifying an item for purchase in the transaction on the platform, the item having one or more product life cycle phases; calculating the item project emissions for a selected item, based at least in part on the emissions associated with each of the one or more product life cycle phases (e.g. raw materials, production, supply-chain transport, warehouse & retail handling, use, disposal and recycling (end of life)) of the selected item; calculating the item baseline emissions for a comparable substitute or equivalent item to the user's selected item, based at least in part on the emissions associated with each of the one or more product life cycle phases (e.g. raw materials, production, supply-chain transport, warehouse & retail handling, use, disposal and recycling (end of life) of the baseline item; calculating delivery project emissions for a project final delivery transport option to the user's specified destination, based at least in part on the emissions associated with each mode of transport and the distance travelled for each mode of transport in the project final delivery transport option; calculating delivery baseline emissions for a baseline final delivery transport option to the user's specified destination, based at least in part on the emissions associated with each mode of transport and the distance travelled for each mode of transport in the baseline final delivery transport option; and extracting the emissions reductions based at least in part on the item baseline and delivery baseline emissions and the item project and delivery project emissions, and delivering the extracted emissions reductions to an independent system for validation and verification. In some embodiments, there may be no need to aggregate emission reductions before validation and verification. For example, by using blockchain the system may be able to verify carbon reductions in real-time without the need to aggregate them from other users or purchases. In other embodiments, the system aggregates the emissions reductions with emissions reductions from other e-commerce purchases, and delivers the aggregated emissions reductions to an independent system for validation and verification.

In some embodiments, calculating of project emissions is additionally based on server emissions produced by energy consumption of one or more environmental impact servers used for determining the emissions data and providing alternative purchasing options to the user. Ownership of the emissions reductions may be assigned to the e-commerce platform. The emissions reductions may include one or more of carbon units, carbon offsets and carbon credits.

Another aspect provides a system of producing verifiable environmental attributes in connection with a transaction on a platform, the system including an environmental impact server configured to: receive from a user an input specifying an item for purchase in the transaction on the platform, the item having one or more life cycle phases; calculate the item project emissions for a selected item, based at least in part on the emissions associated with each of the one or more product life cycle phases (e.g. raw materials, production, supply-chain transport, warehouse & retail handling, use, disposal and recycling (end of life)) of the selected item; calculate the item baseline emissions for a comparable substitute or equivalent item to the user's selected item, based at least in part on the emissions associated with each of the one or more product life cycle phases (e.g. raw materials, production, supply-chain transport, warehouse & retail handling, use, disposal and recycling (end of life) of the comparable item; calculate delivery project emissions for a project final delivery transport option to the user's specified destination, based at least in part on the emissions associated with each mode of transport and the distance travelled for each mode of transport in the project final delivery transport option; calculate delivery baseline emissions for a baseline final delivery transport option to the user's specified destination, based at least in part on the emissions associated with each mode of transport and the distance travelled for each mode of transport in the baseline final delivery transport option; and extract the emissions reductions based at least in part on the item baseline and delivery baseline emissions and the item project and delivery project emissions, and deliver the extracted emissions reductions to an independent system for validation and verification.

In some embodiments, the server is configured to calculate project emissions by accounting for server emissions produced by energy consumption of the server used for determining the emissions data and providing alternative purchasing options to the user. The server may be configured to assign ownership of the emissions reductions to the e-commerce platform. The emissions reductions include one or more of carbon units, carbon offsets and carbon credits.

In addition to the exemplary aspects and embodiments described above, further aspects and embodiments will become apparent by reference to the drawings and by study of the following detailed descriptions.

### BRIEF DESCRIPTION OF THE DRAWINGS

Features and advantages of the embodiments of the present invention will become apparent from the following detailed description, taken in with reference to the appended drawings in which:

FIG. 1 provides a schematic overview of a carbon offset system;

FIG. 2 is a flowchart of the user's experience using the application;

FIG. 3 illustrates the various steps a user will go through when using the application;

FIG. 4 is a schematic illustration of a carbon offset system;

FIG. 5 illustrates a method of determining net GHG emission reductions between a baseline item and a project item;

FIG. 6 illustrates a method of validation, verification and exchange of carbon offsets once net GHG emissions reductions have been determined by a carbon offset system;

FIG. 7 illustrates the flow of goods from business to consumer or business to business;

FIG. 8 illustrates the distribution chain options from factories to retailers or aggregators and then to the end user;

FIGS. 9A, 9B and 9C are mockups of the graphical user interface in each stage of the online purchasing process while using the application.

### DETAILED DESCRIPTION

The description which follows, and the embodiments described therein, are provided by way of illustration of examples of particular embodiments of the principles of the present invention. These examples are provided for the purposes of explanation, and not limitation, of those principles and of the invention.

The present invention provides apparatus, systems and methods for quantifying greenhouse gas (GHG) emissions and emissions reductions in the e-commerce sector.

Throughout this specification, numerous terms and expressions are used in accordance with their ordinary meanings. Provided immediately below are definitions of some terms and expressions that are used in the description that follows. Definitions of some additional terms and expressions that are used are provided elsewhere in the description.

“Mode of delivery” refers to any mode of delivery that can be used to move an item or items from point A to point B, whether over land, water or air. Mode of delivery includes transport by land-based vehicles and land-based transportation systems, including, for example, gas-powered automobiles, rail, various modes of watercraft transport (e.g. ferries), air transport (e.g. aircraft) and remote-controlled vehicles, including delivery by drone (as defined below). Mode of delivery also includes human-powered delivery methods, such as walking, bicycling, skateboarding, scootering, inline-skating and the like.

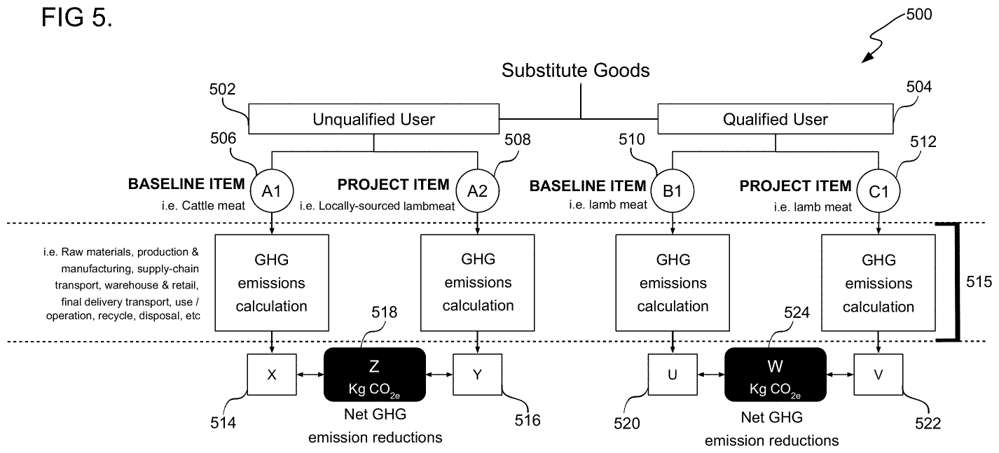

“Environmental attributes” refers to all interests or rights arising from characteristics relating to the environmental impacts associated with an activity, and which include quantifiable, marketable and verifiable environmental attributes, such as GHG reductions in the form of carbon offsets or credits. Carbon offsets or credits are considered an environmental benefit, given that they are derived from some reduction in GHG emissions for a particular activity as compared to the GHG emissions for the equivalent baseline activity. In embodiments described herein GHG emission reductions are recognized at time of purchase through one of these two methods (see FIG. 5): 1) the user buys an item that has a total aggregated emissions that is lower than a baseline item that has a higher carbon footprint (e.g. purchasing locally-sourced lamb meat versus lamb meat imported from New Zealand); and 2) the user buys a comparable product that has a lower carbon footprint than the baseline item (e.g. a user that normally buys lamb meat, thanks to a promotion from the e-commerce site, switches to buying vegan products). Activities that may result in an item having GHG emissions lower than baseline include the use of renewable energy sources during the manufacturing processes, use of low-carbon packaging materials, use of electric delivery vehicles, drones, or delivery couriers, or use of smart logistics' routing, among others. These carbon-reducing activit(ies) exist in any of the phases of the product life cycle, including raw materials, production, supply-chain transport, warehouse and retail handling, customer delivery, use, disposal and recycling (end of life). In some embodiments, the activity may be considered the aggregation of the above-listed sub-activities. Any item option which produces less GHG emissions than the baseline emissions can be considered an activity that produces GHG emissions reductions which can be converted to quantifiable and verifiable emission reductions. Such activity does not require that a user purchase alternative items with lower GHG emissions for the entirety of their order.

“E-commerce eco-optimization application” (also referred to herein as “the eco-optimization app” or “the app”) includes any technology solution that allows a user to see the GHG emissions associated with a particular item and compare to a baseline item. Through the app, the system can display various comparisons of the GHG emissions for selected items to a business as usual baseline. When a user selects an item, the system may display the Item Project Emissions (as defined below) and compare to the Item Baseline Emissions (as defined below). Calculated GHG emissions (Item Project Emissions or Item Baseline Emissions) may include one or more phases of the product life cycle (raw materials through to end of life). In some methodologies, such as Life Cycle Assessment (LCA), the complete life cycle of the product is considered. The Item Baseline Emissions may be determined based on whether the system is able to qualify the user. If a user is a Qualified User (as defined below), the Item Baseline Emissions may be determined based on the user's purchasing patterns/history; if the user is a Unqualified User (as defined below), then the system may determine the Item Baseline Emissions based on non-user purchase data (i.e. system inventory, industry, regional jurisdiction, etc.). As the user adds items to the cart or shopping bag, the system may display the Order Project Emissions (as defined below), as well as the Order Baseline Emissions (as defined below) for the purpose of reference and comparison. Once the user confirms shipping details, the system may calculate the Delivery Project Emissions (as defined below) as well as the Delivery Baseline Emissions (as defined below). The system may also calculate the Project Server Emissions (as defined below), as well as the Baseline Server Emissions (as defined below). Finally, after the user confirms the purchase, the system may calculate Order Emission Reductions (as defined below) and record order details in the server. In particular embodiments, the app is a mobile application that runs on a user's device that enables the user to access an online store and to assist the user with online purchases and enables the user's purchasing history to be tracked for conversion to carbon offsets in accordance with the embodiments described herein. In other embodiments, the user accesses the online store through a web browser installed on the user's device, and similar functionality for displaying Project Emissions, Item Baseline Emissions, etc., is delivered through the web browser portal to the online store.

“Qualified User” (QU) (also referred to as a listed user or registered user) is a user who has downloaded and installed the app onto their user device (or otherwise has customer access to the online store or e-commerce platform (e.g. Amazon) through a web browser or other application installed on the user's device) and has accepted the terms of use or has provided consent to use of their shopping and related GHG emissions data. Such users are listed in a system ledger maintained by a carbon offset system. Each Qualified User is uniquely identified by a system-generated identifier specific to the user's device instance. Unless otherwise specified, a “user” refers to a Qualified User. An “Unqualified User” of “Unlisted User” is a user who is not a qualified, listed or registered user.

“Project item” refers to an actual item being purchased under the carbon offset program.

“Item Project Emissions” (PEi) refers to the determined GHG emissions for each item by the system (which is the aggregation of the emissions generated during one or more product life cycle phases (as defined below).

“Product life cycle activities” refers to stages during a life cycle of a product, from production to end of life, including raw materials, production, supply-chain transport, warehouse and retail handling, use, disposal and recycling (end of life).

“Item Baseline Emissions” (BEi) refers to the GHG emissions generated by a substitute or equivalent baseline item. In some embodiments, Baseline Item Emissions may be related to the emissions generated by equivalent items from the online store's inventory, or from industry-equivalent items. In certain embodiments, the baseline may be: an equivalent product (e.g. replacing beef meat with another beef meat), a product in the same category (e.g. replacing beef meat with chicken meat), or a product in a completely different category of product (e.g. replacing beef meat with tofu or meat analogue). The baseline may be determined by the user, a statistical analysis of the platform's users, or data provided for each jurisdiction. Baseline Item Emissions may be calculated as follows: 1) for Qualified Users, the system may use the user's purchasing history to determine the baseline item or the related activities (manufacturing, transport, etc); and 2) for Unqualified Users, the system may use an aggregate of the e-commerce platform's users, or statistical data based on a geographical region or other parameters to determine the baseline item or its related activities (manufacturing, transport, etc). Calculations for Item Project Emissions and Item Baseline Emissions may be based on an industry-accepted methodology, protocol or standard such as Life Cycle Assessment (LCA), PAS2050, etc.

“Order Project Emissions” (PEo) refers to the aggregate GHG emissions of all selected items in the user's cart or shopping bag.

“Order Baseline Emissions” (BEo) refers to the aggregated total GHG emissions from equivalent baseline items to all selected items in the user's cart or shopping bag.

“Delivery Project Emissions” (PEd) refers to the GHG emissions generated during the final delivery from the nearest distribution centre to the user; these emissions are calculated once the user has confirmed the shipping details for the order.

“Delivery Baseline Emissions” (BEd) refers to the equivalent emissions generated by a business-as-usual delivery option in that region. In cities, an example of business-as-usual delivery would be using a diesel delivery van for online groceries, while a carbon-reducing delivery option could be use of electric vehicles, drones, or bike couriers. Final delivery can happen either from the warehouse (distribution centre), or from the retail store. The delivery emissions depend on the mode of transport used and the distance between either one of these locations and the user.

“Project Server Emissions” (PEs) refers to the GHG emissions generated by the server to handle the order.

“Baseline Server Emissions” (BEs) refers to the GHG emissions generated by a business-as-usual server option.

“Order Emission Reductions” (ERo) refers to the aggregated GHG emission reductions generated by the order, recognized at the time of purchase. In some embodiments, the calculation of emission reductions may be made for each product lifecycle phase, and are deducted on a phase-by-phase basis, or as an aggregate for the product and baseline. Emission reductions for a product may be calculated by summing emission reductions generated by one or more steps of the product lifecycle when compared to a baseline product. For example, in the case of an electric vehicle (EV): EV emission reductions=(Gasoline vehicle raw material emissions−EV raw material emissions)+(Gasoline vehicle production emissions−EV production emissions)+(Gasoline vehicle use emissions−EV use emissions)+(Gasoline vehicle End of Life emissions−EV End of Life emissions).

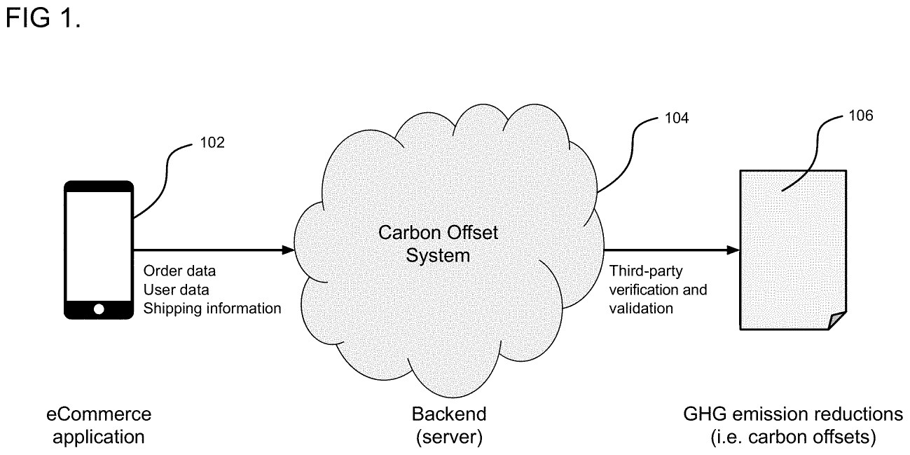

FIG. 1 provides a schematic overview of a carbon offset system 104 according to one embodiment of the invention. Carbon offset system 104 is a system capable of producing environmental benefits such as the aggregation and quantification of verifiable GHG emission reductions generated by one or more activities involved during complete product life cycle, including raw materials, production, supply-chain transport, warehouse and retail handling, customer delivery, use, disposal and recycling (end of life) of items purchased online, or by the emissions reductions produced through the substitution of a low-GHG emission item for a high-GHG emission item during the purchasing process. In some embodiments, there are two types of substitution that are considered: i) Product substitution within the same product category (i.e. laptop A for laptop B); and (ii) Product substitution within different categories (i.e. laptop A for iPad A). In either of these two cases, if the selected product has a lower carbon footprint, then carbon reductions are recognized. The quantification and production of carbon offsets from e-commerce activities is achieved by deducting the baseline emissions from the project emissions for each item added to the shopping cart. Order emission reductions (the aggregate of all items included in the shopping cart) are recognized at the time of purchase, and once verification is complete they are converted to carbon units (carbon offsets, credits, etc.) These e-commerce activities are carried out using the app or a web browser installed on a user device 102 that is in communication with the carbon offset system 104. User device 102 may comprise any electronic device, including a computer, tablet, cellular phone or smartwatch, that is capable of accessing an online store through the app or web browser. As the user browses the online store on a user device 102, the system displays GHG emissions for each item and the GHG emissions generated by a baseline item. To encourage users to purchase items with a low-carbon footprint, the system may categorize items based on environmental criteria, such as low-carbon items, locally-sourced items, low-carbon delivery options, and substitution of high-carbon product for a low-carbon product (e.g. meat-based diet to vegan diet) or use of a product with low operational carbon (e.g. battery electric vehicles (BEVs) instead of gasoline-powered vehicles, etc). Once the user confirms the shipping details the carbon offset system 104 may calculate the GHG emissions generated during the final delivery from the nearest distribution centre or retail location to the user (Delivery Project Emissions, or PEs) as well as the equivalent emissions generated by a business-as-usual delivery option in that region (Delivery Baseline Emissions, or BEs). In some embodiments, the system may require the user to input information to determine the use, disposal and/or recycling of the product to determine the appropriate GHG emissions (i.e. annual projected mileage of an electric vehicle during the purchase/lease process). Finally, after the user confirms the purchase, the system may calculate the GHG emission reductions generated by the Order (Order Emission Reductions, or ERo) and GHG emission reductions are recognized and recorded in the server. The resulting GHG emission reductions across all user purchases may be aggregated by the carbon offset system 104 and converted to verifiable emission reductions, which can be validated and verified for the purpose of having them being recognized as carbon units, depicted as VCUs 106 in FIG. 1. The conversion of the e-commerce purchases of users to GHG emissions reductions data and carbon offsets is performed in accordance with one or more methodologies and project plan as described in more detail herein.

Vendors and providers of e-commerce platforms (i.e. manufacturers, logistics' vendors, and the like, such as Foxconn, Penske, Emterra, etc.) and consumers may be required to transfer the ownership of the carbon emissions (or carbon reduction) generated during their subsequent steps (manufacturing, transport, delivery, use, recycling) to the e-commerce platform owner or provider. This may be required for the e-commerce platform owner to be able to aggregate the carbon reductions generated by a single vendor, or quantify the difference between two vendors to generate carbon offsets in the future. While the examples described herein are in relation to the purchase of items over an e-commerce platform, the systems and methods described herein can apply to any kind of transaction facilitated over an e-commerce platform, such as a lease or rental transaction.

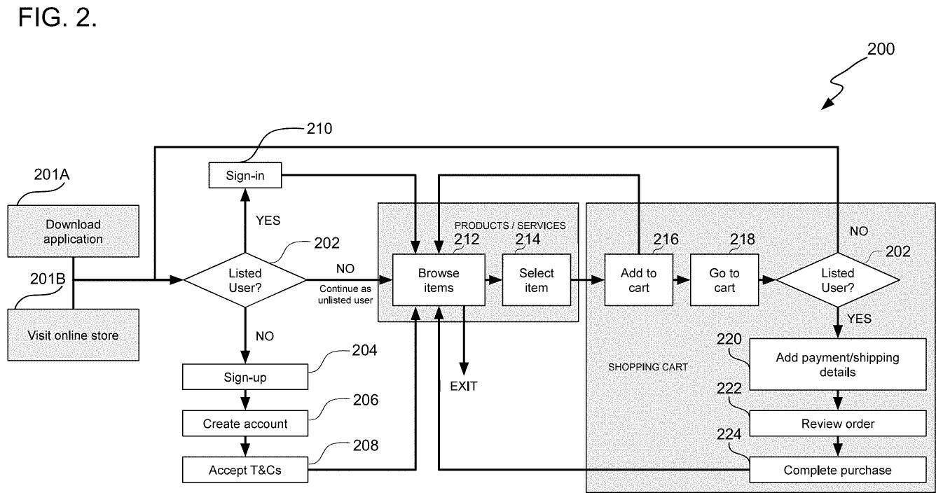

FIG. 2 illustrates method 200 performed by a user interacting with the app installed on a user's device 102. Method 200 begins at block 201A or 201B with a user downloading and installing the app or visiting an online store on the user's device 102. If the user is not a listed user (block 202), the user can continue as an unlisted user, or become a listed or qualified user by signing up (block 204), creating an account (206) and accepting the terms and conditions (208). Users who are already registered or qualified have the option to sign-in 210 as a listed user. Once a user is signed in as a listed user or is choosing to continue as an unlisted user, they are able to browse (block 212), select (block 214) and add (216) items to their cart. Once they are finished browsing items, they can continue to their cart (block 218) to view all of their selected items. If they are a listed user, they can continue on to add their payment and shipping information (block 220), review their order (block 222), and complete their purchase (block 224). The system may aggregate the GHG emissions of all selected items, taking into account the shipping details from block 220, as well as the aggregated total GHG emissions from equivalent items, and display that information to the user when reviewing their order at block 222. Once the purchase is complete at block 224, the system may calculate the ERo and record order details in the server.

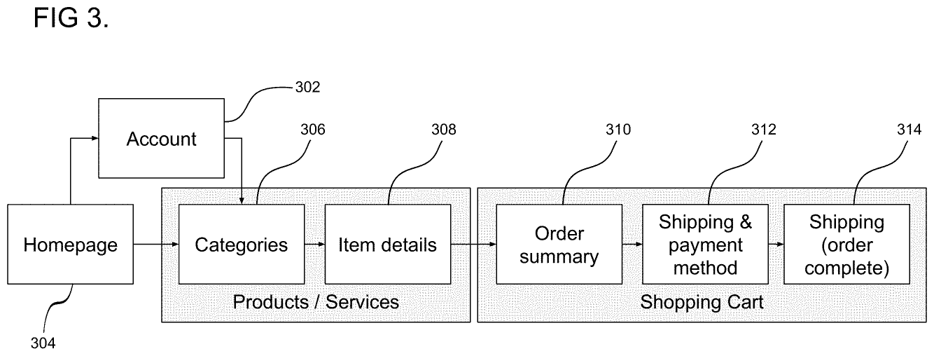

FIG. 3 illustrates the various steps a user will perform throughout the online ordering process of the online store as accessed by the user through the app or web browser. At block 304 a user accesses the homepage of the online store. The user can either sign-in to their account at block 302 prior to browsing the categories of products at block 306 or skip the sign-in process and continue as an unlisted user to block 306. The user can view item details at block 308 and decide whether or not to add the item to their cart or shopping bag. When the user is viewing selected items, the system may display to the user the PEi and BEi for a given item. Once the user is finished selecting items, they can continue to block 310 to view their order summary which may display the PEo and BEo for the particular order. The user inputs shipping and payment methods at block 312, and with this information, the system calculates to PEd and BEd. At block 314, the user confirms and completes the order allowing for the ERo to be calculated and the order details are recorded in the server. How the system calculates each of these values (i.e. PEo, BEo, and ERo) according to one embodiment is explained in further detail below.

At block 306, the system may categorize items based on environmental criteria, such as low-carbon items (i.e. vegan, meat replacement, etc), locally-sourced items, or low-carbon delivery options, to encourage a reduction of GHG emissions generated by the order. The user can use these categories to inform their purchasing habits. In some embodiments, GHG emission reductions may be generated as a consequence of the user's decision to opt for low-carbon food items over high-carbon food times (e.g. choosing vegan food products over meat-based food products). The carbon impact of user behaviour may be considered and calculated as part of the overall Item Project Emissions. Depending on whether the user is qualified or not, the additionality provided by the system is demonstrated by one or more of: the user's purchasing habits (history), statistical analysis of the purchasing habits of the users of the e-commerce platform, or statistical analysis of the purchasing habits of a population group in a defined geographical region, or a combination of all the above.

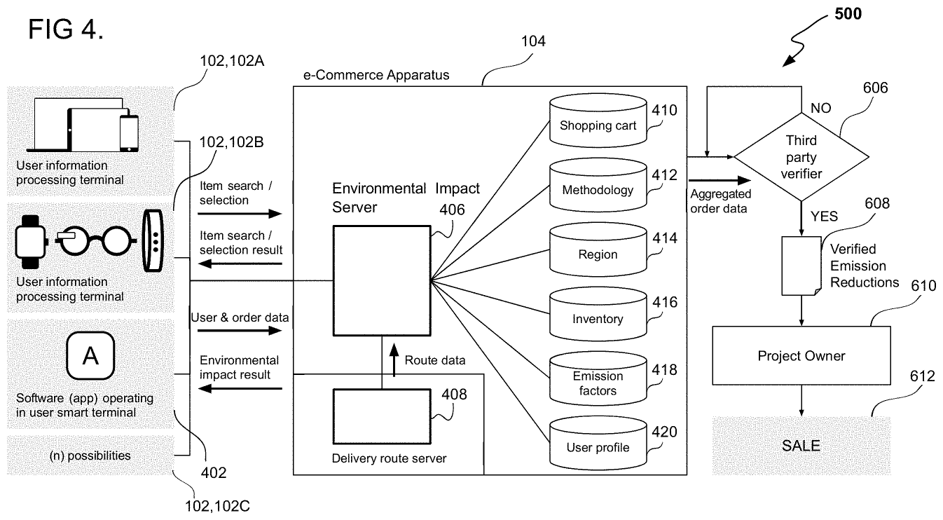

FIG. 4 illustrates a technology-driven carbon offset system 104 according to one embodiment. System 104 is operable to reduce GHG emissions for a particular project or carbon offset program within an environment 400 that includes a plurality of user devices 102 (referred to as a user information processing terminal in the illustration). Representative user devices 102 are shown, consisting of a smartphone, tablet or laptop 102A, and smartwatches and the like 102B. Each user device 102 contains a processor that can execute instructions provided by software 402 (such as the app) and is operable to connect to a wireless communication network. The wireless communication network may comprise a cellular phone or mobile network, a satellite communication network, terrestrial microwave network, or any other suitable wireless network or combination thereof. User devices 102 function as information processing terminals which communicate with the carbon offset system 104 over the wireless communication. Each user device 102 is operated by its respective user as the user completes online e-commerce orders, following viewing selected items on the app. Besides the user devices 102A, 102B shown, other types of user devices 102C that are capable of executing software instructions and communicating with a carbon offset system 104 over a wireless communication network may be used.

Environment 400 also includes a verification system 606 for performing a verification process 606 (typically through an independent third party) once data from the carbon offset system 104 is transferred to the verification system. Verification system includes components for validating and verifying carbon offset data provided by the carbon offset system 104 to produce a verification statement by the third party to facilitate issuance of verified carbon reductions 608 (e.g. in the form of offsets or credits) that can be recorded in a registry and made available for sale, transfer, banking or retirement by the project owner 610. The project owner 610 is the owner of the GHG emissions reductions for the particular project or carbon offset program and has the power to sell 612 the verified emission reductions 608.

The carbon offset system 104 of FIG. 4 includes an environmental impact server 406 which is in communication with user devices 102 over the wireless communication network. Environmental server 406 is also in communication with one or delivery route servers 408. Environmental impact server 406 receives from each user device 102 the user's order information and the user's input (desired) delivery details, provided through the app (or web browser) that is installed on the user device 102. The environmental impact server may calculate the product life cycle emissions (e.g. cradle to gate, cradle to consumer, cradle to grave, or cradle to grave—open loop recycling, among others) or collect GHG emission data from existing databases, locally or from third-parties, for both items in the online store's inventory as well as the relevant baseline items. The environmental impact server 406 requests, from the one or more delivery route servers 408, delivery details to take the user's order from its current location to the desired final delivery destination using alternative (non-baseline) modes of delivery that have reduced GHG emissions over the baseline delivery. Examples of baseline delivery include diesel or gasoline-powered delivery vans and gasoline cars. Some examples of alternative (non-baseline) delivery include LNG-powered vans, BEV or PHEV vans/cars, bike couriers and drones. In some cases, both the project delivery and the baseline delivery may be the same, in which case no emission reductions would be accrued. The delivery route servers 408 return the available delivery options to the environmental impact server 406, which communicates the delivery options (including details for each option) to the user device 102 and displays them on the user interface provided in the app. Some or all of the delivery options may incorporate a plurality of modes of transport such as rail, truck/van, EV truck/van, walking, bicycling, ferry, plane, etc. Using the user interface provided through the app or web browser on the user's device, the user selects one of the delivery options and completes the order.

Servers or data sources that are part of the carbon offset system 104 and which store programs or data that are accessible and managed by the environmental impact server 406 may include shopping cart data 410, methodology server 412 (storing programs for determining net GHG emission reductions from user order data), region data store 414 (storing other information specific to each geographic region), inventory data store 416 (such as all available purchasing options for a particular item), emissions factor data store 418 (storing information such as emissions factors for each delivery option in each geographic region), and user profile data store (storing information such a purchasing history for each qualified user).

FIG. 5 illustrates method 500 for determining the net GHG emission reductions for Unqualified Users 502 and Qualified Users 504. Generally, net GHG emission reductions can be calculated by determining the difference between a Project Item (PEi) and a Baseline Item (BEi). The quantification of carbon emissions is for each ‘activity’ within the different phases of the product life cycle. Examples may include use of renewable power during manufacturing, or in warehouses, use of low-carbon fuels during transport, etc. Alternatively, the system may consider the activity as the aggregation of all these sub-activities as one. The BEi may be determined differently depending on whether the user is qualified user or unqualified user. For a Qualified User 504, the BEi may be determined based on the user's purchasing patterns/history; for an Unqualified User 502 the system may determine the BEi based on non-user purchase data (i.e. system inventory, industry, regional jurisdiction, etc.). GHG emissions associated with a particular activity or item may be calculated according to a recognizable methodology or protocol, including for example, Life Cycle Analysis (LCA), a GHG quantification methodology (i.e. Verra (VCS Program), Gold Standard, etc.), GHG Protocol, PAS2050, ISO 14064-2, and the like. In particular embodiments, GHG emissions reductions are recognized only at the time of purchase (rather than for each activity).

The net GHG emission reductions 518 for the Unqualified User 502 are determined by subtracting the total GHG emissions 516 from the PEi 508 from the total GHG emissions 514 from the BEi 506. Blocks 514 and 516 are the summation of all GHG emissions from the activities associated with raw materials, production, supply-chain transport, warehouse and retail handling, customer delivery, use, disposal and recycling (end of life) for the BEi 506 and PEi 508, respectively. Similarly, the net GHG emission reductions 524 for the Qualified User 504 are determined by subtracting the total GHG emissions 522 of the PEi 512 from the total GHG emissions 520 of the BEi 510. Blocks 520 and 522 are the summation of all GHG emissions from the activities associated with raw materials, production, supply-chain transport, warehouse and retail handling, customer delivery, use, disposal and recycling (end of life) for the BEi 510 and PEi 512, respectively.

If the PEi and BEi represent the entirety of the order, they can be referred to as PEo and BEo. According to a particular embodiment, the PEo for a completed order is calculated as follows:

$$P E o = {\sum }_{1}^{n} ( P E i ) + P E s + P E d$$

where:
n is the total number of items in the order;
PEᵢ is the emissions for an Item in the order, which varies from product to product; for example, for an electric vehicle, its product emissions PEᵢ may be calculated as follows: PEᵢ=(raw materials) emissions+(production) emissions+(logistics) emissions+(end user delivery) emissions+(use) emissions+(end of life) emissions;
PEₛ is the emission allocation for electricity generation used for running the servers. In particular embodiments, server emissions are calculated based on the emissions factors of electricity for the geographic region in which the environmental impact server(s) of the carbon offset system are located; and
PE_{d} is the emissions generated during the delivery of the order from the distribution centre to the user.

Similarly, the BEo for a completed order is calculated as follows:

$$B E o = {\sum }_{1}^{n} ( B E i ) + B E s + B E d$$

where:
n is the total number of equivalent items in the order;
BEᵢ is the emissions for an equivalent item in the order (similarly to product emissions PEᵢ, baseline item emissions BEᵢ varies between items; for example, for a substitute item to an electric vehicle (such as an electric hybrid vehicle), baseline item emissions BEᵢ may be calculatd as follows: BEᵢ=(Raw materials) emissions+(Production) emissions+(Logistics) emissions+(End user delivery) emissions+(Use) emissions+(End of Life) emissions);
BEₛ is the emissions for an equivalent server, where an equivalent server is one that is “business-as-usual” located in the same geographical region as the project server (in some cases, the server may run using renewable energy so its footprint will be small, while in some other cases, the server may run using fossil fuels; the project proponent will need to determine the baseline emissions for a server located in the same region as the project server); and
BE_{d} is the emissions for an equivalent order delivery; this is determined on an item by item basis, and its corresponding carbon-reducing activities under a business-as-usual scenario.

Once the system has calculated PEo and BEo for a completed order the ERo may be determined. Net emission reductions ERo for a completed order can be calculated as follows in certain embodiments:

ERo=BEo−PEo−LEo

where:
ERₒ is the Emission Reductions generated by the order;
BEₒ is the Baseline Emissions from the equivalent order;
PEₒ is the Project Emissions generated by the order; and
   LEₒ is the Leakage from the order of Items (where applicable).
Leakage is applicable only if (a) the carbon-reducing activity is the online purchase of an item. For (b) the usual aggregation of carbon-reducing activities for a particular item, leakage is not applicable in the calculations. For (a) there may be a case where a user decides not to purchase items online through the e-commerce platform due to carbon impact generated, and instead purchases them from a local store. Leakage may be considered negligible in certain embodiments (e.g. as it is considered a fringe case), or accounted for in other embodiments. In such cases, leakage is omitted from the above formula.

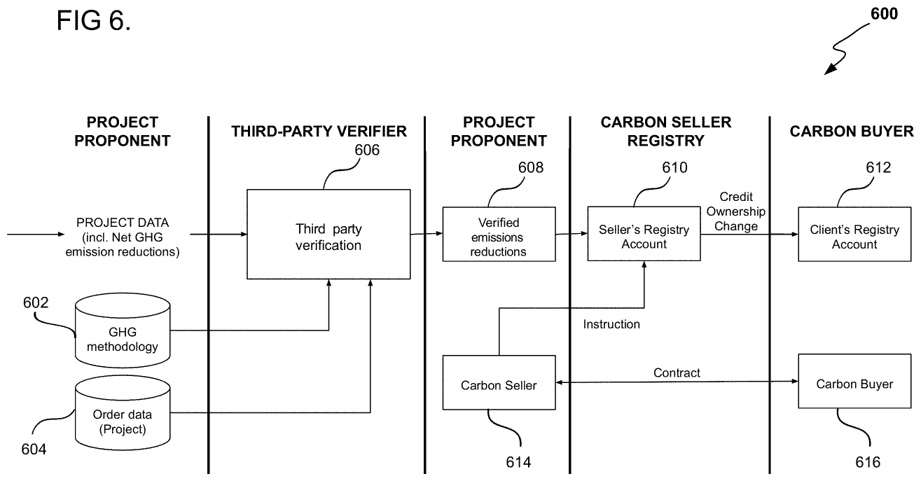

FIG. 6 illustrates a data flowchart for method 600 of how GHG emission reductions are verified and converted into tradable environmental benefits such as carbon offsets. The carbon offset or project data (including net GHG reductions) obtained using methodology 412 for determining the net GHG reductions and the order data 604 for a completed user order are provided to a third party verification system 606. Verification system 606 verifies the carbon offset data to produce a verification statement to facilitate the issuance of verified emissions reductions 608 (e.g. in the form of offsets or credits, which may be referred to as Verified Emission Reductions or Voluntary Emission Reductions (VERs), or Certified Emission Reductions (CERs) under different programs). The verified emissions reductions 608 are typically recorded on a registry account 610 that is held by a party 614 looking to transact the carbon offsets (which party can be the project owner or provider of the e-commerce carbon reduction technologies described herein). When a party 614 selling carbon offsets enters into a contract to transfer the verified emissions reductions 608 to a carbon offset buyer 616, the buyer's registry account 612 (along with the seller's registry account 610) is updated to reflect the transfer.

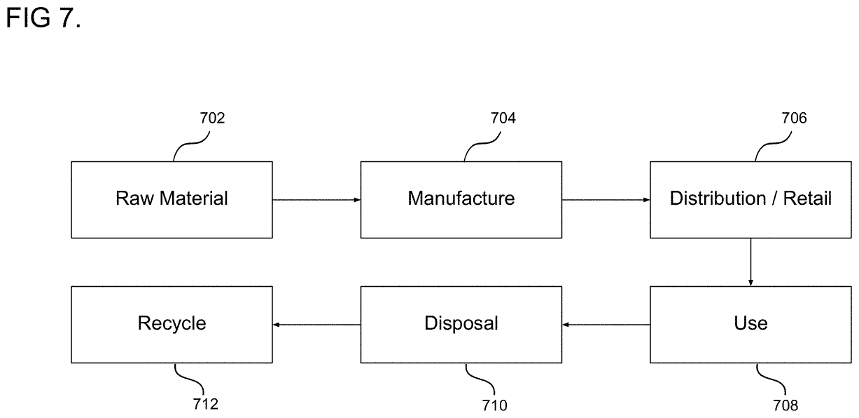

FIG. 7 depicts the typical product life cycle phases of consumer products. At block 702 the raw materials are acquired. Depending on what the raw materials are, the overall GHG emissions of an item can differ greatly (i.e. aluminium vs plastic). At block 704 the raw materials are manufactured into the final item. The types of manufacturing processes and packaging can further impact the GHG emissions associated with an item. Use of renewable energy during the manufacturing and/or processing steps and using recycled or bulk packaging are examples of production activities that may result in an item having lower GHG emissions than a comparable item. At block 706 the manufactured item is sold by a distributor or retailer. Warehouse and retail activities can generate GHG emission reductions through the use of renewable energy in buildings, use of low-carbon logistics' equipment (i.e. electric forklift), and high-efficiency HVAC, lighting, or mechanical systems. The item then undergoes final delivery transport to the customer. The customer uses the item at block 708 (which itself can produce GHG emissions reductions over use of a baseline item). The supply chain transport activities and final transport activities that occur between blocks 702, 704, 706 and 708 also generate potential GHG emission reductions by switching from trucking to rail for long-distance ground transport, using low carbon delivery transport modes (i.e. EV/Hybrid van/truck, courier, e-moped), and smart routing (i.e. use of GPS-based algorithms in delivery trucks to improve routing accuracy). Every item purchased by a consumer must eventually be disposed of 710 or recycled 712, which has an impact on the overall GHG emissions associated with that item. For example, some products might be easier to recycle 712 and therefore produce lower GHG emissions than the baseline when it comes time to get rid of them; whereas some items may be destined for disposal 710 due to the inherent characteristics of the item.

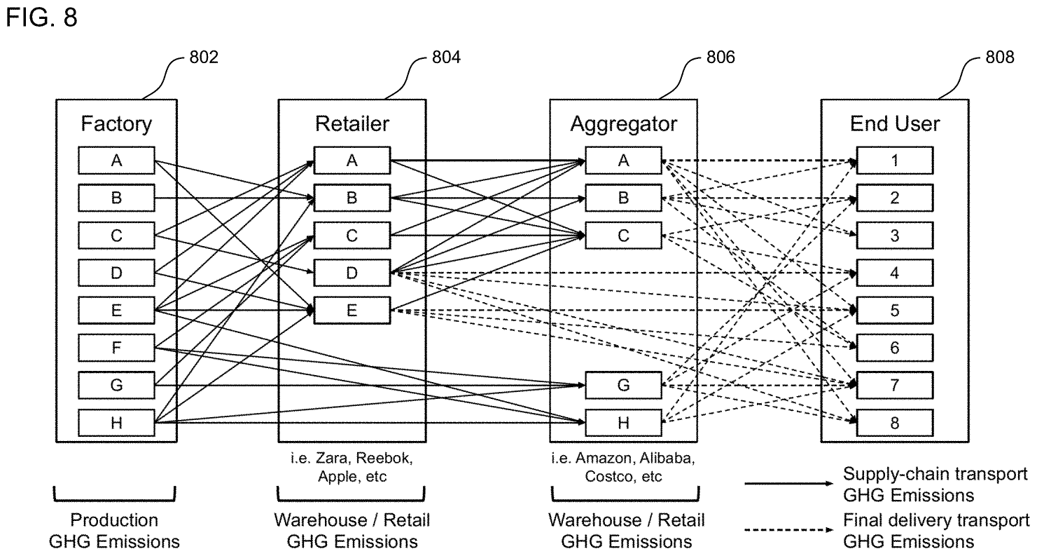

FIG. 8 illustrates the multitude of distribution chain options that an item may take from production to final delivery. At block 802, factories A through H all have potentially different GHG emissions associated with item production, even if they are all producing the same or similar items. Factors that can impact the GHG emissions at the production phase include the use of renewable energy during manufacturing and/or processing, recycled and bulk packaging, and low carbon materials (i.e. aluminum vs plastic), and location of the manufacturing facility (e.g. locally-grown produce versus imported produce). A manufacturing facility located closer to the customer produces GHG emissions reductions, even when using the same transport mode (e.g. diesel truck). At blocks 804 and 806, the same variations can occur at the stores and warehouses of retailers and aggregators. Activities that can reduce the GHG emissions at retailers 804 and aggregators 806 include the use of renewable energy in buildings, low-carbon logistics' equipment (i.e. electric forklift), and high-efficiency HVAC, lighting, or mechanical systems. Further, some items may bypass either retailers 804 or aggregators when moving through the distribution chain form factory 802 to the end user 808, altering its overall GHG emissions. Supply chain transport activities between the factory 802, retailer 804, and aggregator 806 can cause variance in the total GHG emissions of an item. One example of a supply chain transport activity that would reduce GHG emissions is switching from trucking to rail for long-distance ground transport, switching from diesel or gas to low-carbon fuels in any mode of transport (e.g. LNG, BEV). The final delivery transport activities from the retailer 804 or aggregator 806 to the end user 808 also factor into an items total GHG emissions. Activities such as low-carbon delivery transport mode (i.e. EV/Hybrid van/truck, courier, e-moped, etc) and smart routing (i.e. use of GPS-based algorithms in delivery trucks to improve routing accuracy) will reduce the overall GHG emissions of an item. The system takes all these variations into account to provide accurate GHG emissions for items and allow consumers to make informed, environmentally conscious e-commerce decisions.

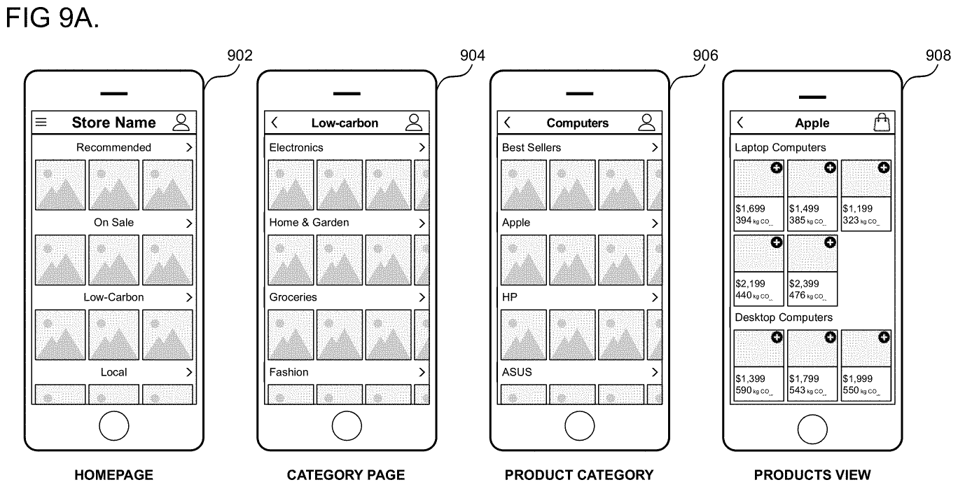

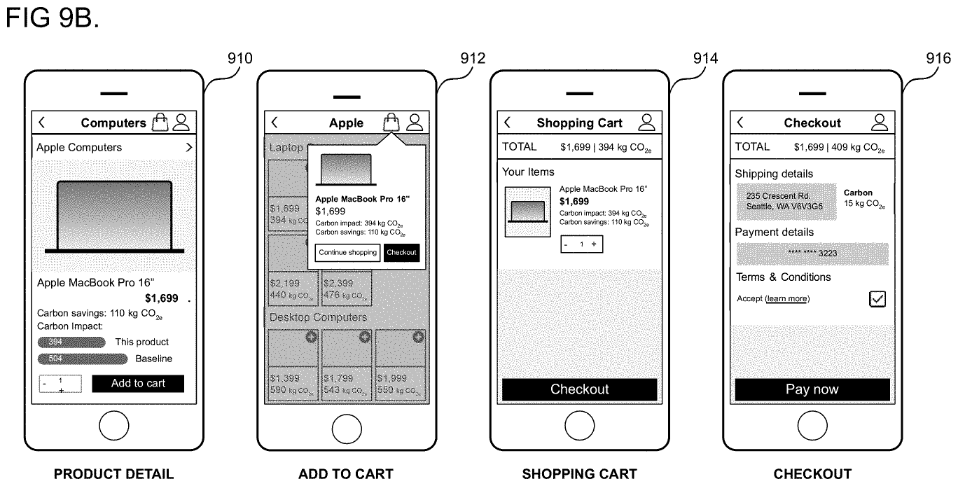

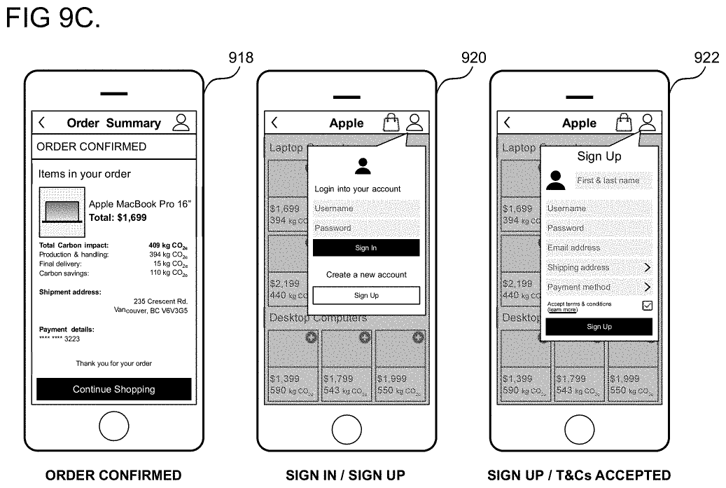

FIGS. 9A, 9B and 9C are mockups of the graphical interface for the app during different steps of the ordering process. Block 902 is a mockup of the homepage 304 that the user will see upon opening the app. The app has sorted items into categories 306, including GHG based categories such as low-carbon and local. The user can then browse items 212 by expanding a desired category, shown at block 904, to view more purchase options of interest. At block 904, items within the low-carbon category page are further categorized into item types, such as electronics, groceries, fashion, and home and garden. The user can also browse items in a more specific way by viewing purchasing options for a particular item type (i.e. computers), shown at block 906. In mockup 906, the user is viewing computers and the app has sorted them by brand. If the user selects a particular brand category, the app may display more details about each item such as price and GHG emissions, shown at block 908. From here, the user may select a specific item 212 to view item details 308. At block 910, a mockup of a selected item is shown and the app displays the carbon impact and carbon reductions relative to baseline for that specific item. The user can then add this item to their cart 216 and choose to either continue shopping or checkout 916. At checkout 916, the user is prompted to enter their shipping and payment details 220 so the system may calculate the orders overall GHG emissions taking final delivery transport into consideration. At block 918, an order summary 310 is provided which shows a breakdown of the GHG emissions associated with each stage (e.g. production, handling, final delivery) for the item being ordered. Finally, at block 920 and 922, if the user is not already signed-in it will prompt the user to sign-in 210 or sign-up 204. If sign-up 204 is required, the user will need to create an account 206 and accept the terms and conditions 208 of the app.

In alternate embodiments, functionality of the app as described herein can be implemented by third-party e-commerce applications of retailers and aggregators running on user devices such as laptops, smartphones, smartwatches and the like. These applications can interact with the environmental impact server of a carbon offset system to convert online purchases of users to verifiable emission reductions.

While exemplary embodiments described herein relate to purchases by end consumers conducted over e-commerce platforms, the systems and methods described herein may be adapted to be used for any transaction, such as Business to Business (B2B) transactions, Business to Consumers (B2C) transactions, Consumer to Consumer (C2C) transactions, and Business to Government (B2G) transactions. These transactions may be conducted over platforms that include online commerce platforms, such as e-commerce platforms and online trading platforms, accounting systems, online payment systems, and the like. In other embodiments, the systems and methods described herein may be adapted to be used for transactions conducted in stores. For such embodiments, the user device may include point of sale (POS) devices for in-store purchases.

In the above-described embodiments, delivery emissions is considered separately from the product lifecycle emissions. One example where it may be suitable to consider the delivery emissions separately from the product lifecycle emissions is for an online grocery order or any other order involving multiple items delivered together to the purchaser. As such, the calculations for product emissions PEₒ for a completed order may use the following formula, as explained above:

PEo=Σ₁ⁿ(PEi)+PEs+PEd

In certain other embodiments, product delivery emissions is considered as part of the product lifecycle emissions (e.g. home delivery of a single product by an electric vehicle). In such cases, product emissions PEo for a completed order may be calculated using the following formula:

$$P E o = {\sum }_{1}^{n} ( P E i ) + P E s$$

where:
n is the total number of items in the order;
PEᵢ is the emissions for an Item in the order (which includes product emissions across all the product lifecycle phases, including product delivery emissions); and
PEₛ is the emission allocation for electricity generation used for running the servers. In particular embodiments, server emissions are calculated based on the emissions factors of electricity for the geographic region in which the environmental impact server(s) of the carbon offset system are located. In certain other embodiments, server emissions are negligible and are omitted from the above formula.

Likewise, the baseline product emissions BEo for a completed order are calculated as follows:

$$B E o = {\sum }_{1}^{n} ( B E i ) + B E s$$

where:
n is the total number of equivalent items in the order;
BEᵢ is the emissions for an equivalent item in the order (which includes emissions for the equivalent item across all its product lifecycle phases, including baseline item delivery emissions); and
BEₛ is the emissions for an equivalent server, where an equivalent server is one that is “business-as-usual” located in the same geographical region as the project server (in some cases, the server may run using renewable energy so its footprint will be small, while in some other cases, the server may run using fossil fuels; the project proponent will need to determine the baseline emissions for a server located in the same region as the project server). In certain other embodiments, server emissions are negligible and are omitted from the above formula.

The examples and corresponding diagrams used herein are for illustrative purposes only. Different configurations and terminology can be used without departing from the principles expressed herein.

Although the invention has been described with reference to certain specific embodiments, various modifications thereof will be apparent to those skilled in the art without departing from the scope of the invention. For example, variants of the system described herein may include:
a carbon system aggregator for multiple e-commerce sites, where a single carbon system provides the GHG emissions for each item on multiple platforms, calculates carbon reductions for each order and aggregates the verifiable carbon reductions for verification.
a voice-based system (ie. Alexa, Siri, etc) that aids the end-user through the online purchasing process, providing carbon impact information for each product.
an infotainment-based carbon system that provides an online platform to e-commerce sites within moving vehicles.
a distributed system where each vehicle infotainment systems allows end-user to access one or more e-commerce sites and a centralized system (e.g. a system owned by the OEM manufacturer) hosts the carbon system, calculates GHG emissions for each project and baseline item, calculates the GHG reductions for each order, and aggregates net GHG reductions for all vehicles and sends them to a third-party verifier.
   The scope of the claims should not be limited by the illustrative embodiments set forth in the examples, but should be given the broadest interpretation consistent with the description as a whole.

1. A method of producing verifiable environmental attributes in connection with a transaction on a platform, comprising:
(a) receiving from a user an input specifying an item for purchase, lease and/or rental in the transaction on the platform, the item having one or more product life cycle phases;
(b) calculating the item project emissions for a selected item, based at least in part on the emissions associated with each of the one or more product life cycle phases of the selected item;
(c) calculating the item baseline emissions for an equivalent item to the user's selected item, based at least in part on the emissions associated with each of the one or more product life cycle phases of the equivalent item;
(d) extracting the emissions reductions based at least in part on the item baseline emissions and the item project emissions, and delivering the extracted emissions reductions to an independent system for validation and verification.

2. The method of claim 1 wherein calculating project emissions is additionally based on server emissions produced by energy consumption of one or more environmental impact servers used for determining the emissions data and providing alternative purchasing options to the user.

3. The method of claim 1, comprising assigning ownership of the emissions reductions to the platform.

4. The method of claim 3 wherein the emissions reductions comprise one or more of carbon units, carbon offsets and carbon credits.

5. The method of claim 2 wherein the server emissions are calculated based on the emissions factors of electricity for the geographic region in which the environmental impact server(s) are located.

6. The method of claim 1 wherein the user selects one or more items for purchase in a project order, and calculating project emissions for the project order comprises summing emissions from a plurality of segments of item production and distribution in accordance with the following:
$$P E o = {\sum }_{1}^{n} ( P E i ) + P E s + P E d$$
where:
n is the total number of items in the project order;
PEᵢ is the emissions for an item in the project order;
PEₛ is the emission allocation for electricity generation used for running the servers; and
PE_{d} is the emissions generated during the delivery of the project order from the distribution centre to the user.

7. The method of claim 6 wherein calculating baseline emissions for a baseline order comparable to the project order comprises summing emissions from a plurality of segments of the baseline item production and distribution in accordance with the following:
$$B E o = {\sum }_{1}^{n} ( B E i ) + B E s + B E d$$
where:
n is the total number of equivalent items in the baseline order;
BEᵢ is the emissions for an equivalent item in the baseline order;
BEₛ is the emissions for an equivalent baseline server; and
BE_{d} is the emissions for a baseline order delivery.

8. The method of claim 1 wherein emission reductions for the project order compared to the baseline order are extracted in accordance with the following:
ERo=BEo−PEo
where:
ERₒ is the Emission Reductions generated by the project order;
BEₒ is the Baseline Emissions from the baseline order; and
PEₒ is the Project Emissions from the project order.

9. The method of claim 1 wherein extracting the emissions reductions comprises subtracting leakage, where applicable, from a difference between the baseline emissions and the project emissions.

10. The method of claim 1 comprising displaying a plurality of purchasing options for comparable items having reduced emissions over the baseline item option.

11. The method of claim 1 wherein the user selects one or more items for purchase in a project order, and calculating project emissions for the project order comprises summing emissions from a plurality of segments of item production and distribution in accordance with the following:
$$P E o = {\sum }_{1}^{n} ( P E i )$$
where:
n is the total number of items in the project order; and
PEᵢ is the emissions for an item in the project order.

12. The method of claim 11 wherein calculating baseline emissions for a baseline order comparable to the project order comprises summing emissions from a plurality of segments of the baseline item production and distribution in accordance with the following:
$$B E o = {\sum }_{1}^{n} ( BEi )$$
where:
n is the total number of equivalent items in the baseline order; and
BEᵢ is the emissions for an equivalent item in the baseline order.

13. A system of producing verifiable environmental attributes in connection with a transaction on a platform, the system comprising an environmental impact server configured to:
(a) receive from a user an input specifying an item for purchase, lease and/or rental in the transaction on the platform, the item having one or more product life cycle phases;
(b) calculate the item project emissions for a selected item, based at least in part on the emission factors associated with each of the one or more product life cycle phases of the selected item;
(c) calculate the item baseline emissions for an equivalent item to the user's selected item, based at least in part on the emission factors associated with each of the one or more product life cycle phases of the equivalent item;
(d) extract the emissions reductions based at least in part on the item baseline and the item project emissions, and deliver the extracted emissions reductions to an independent system for validation and verification.

14. The system of claim 13 wherein the server is configured to calculate project emissions by accounting for server emissions produced by energy consumption of the server used for determining the emissions data.

15. The system of claim 13, wherein the server is configured to assigned ownership of the emissions reductions to the platform.

16. The system of claim 13 wherein the emissions reductions comprise one or more of carbon units, carbon offsets and carbon credits.

17. The system of claim 14 wherein the server is configured to calculate server emissions based on the emissions factors of electricity for the geographic region in which the server is located.

18. The system of claim 13 wherein the server is configured to accept a selection of one or more items for purchase in a project order, and calculate project emissions for the project order by summing emissions from a plurality of segments of item production and distribution in accordance with the following:
$$P E o = {\sum }_{1}^{n} ( P E i ) + P E s + P E d$$
where:
n is the total number of items in the project order;
PEᵢ is the emissions for an item in the project order;
PEₛ is the emission allocation for electricity generation used for running the servers; and
PE_{d} is the emissions generated during the delivery of the project order from the distribution centre to the user.

19. The system of claim 18 wherein the server is configured to calculate baseline emissions for a baseline order comparable to the project order by summing emissions from a plurality of segments of the baseline item production and distribution in accordance with the following:
$$B E o = {\sum }_{1}^{n} ( B E i ) + B E s + B E d$$
where:
n is the total number of equivalent items in the baseline order;
BEᵢ is the emissions for an equivalent item in the baseline order;
BEₛ is the emissions for an equivalent baseline server; and
BE_{d} is the emissions for a baseline order delivery.

20. The system of claim 13 wherein the server is configured to extract emissions reductions for the project order as compared to the baseline order in accordance with the following:
ERo=BEo−PEo
where:
ERₒ is the Emission Reductions generated by the project order;
BEₒ is the Baseline Emissions from the baseline order; and
PEₒ is the Project Emissions from the project order.

21. The system of claim 13 wherein the server is configured to account for leakage in the emissions reductions, where applicable, by subtracting leakage from a difference between the baseline emissions and the project emissions.

22. The system of claim 13 wherein the server is configured to compile a plurality of purchasing options for comparable items having reduced emissions over the baseline item option.

23. The system of claim 22 wherein the server is configured to accept a selection of one or more items for purchase in a project order, and calculate project emissions for the project order by summing emissions from a plurality of segments of item production and distribution in accordance with the following:
$$P E o = {\sum }_{1}^{n} ( P E i )$$
where:
n is the total number of items in the project order; and
PEᵢ is the emissions for an item in the project order.

24. The system of claim 23 wherein the server is configured to calculate baseline emissions for a baseline order comparable to the project order by summing emissions from a plurality of segments of the baseline item production and distribution in accordance with the following:
$$B E o = {\sum }_{1}^{n} ( BEi )$$
where:
n is the total number of equivalent items in the baseline order; and
BEᵢ is the emissions for an equivalent item in the baseline order.
